(19) United States
(12) Patent Application Publication
(10) Pub. No.: US 2016/0073425 A1
(43) Pub. Date: Mar. 10, 2016

(54) Method and Apparatus for Transmitting Uplink Signal

(71) Applicant: Huawei Technologies Co., Ltd., Shenzhen (CN)

(72) Inventors: Shifang Xu, Shenzhen (CN); Zhijun Chao, Shanghai (CN)

(21) Appl. No.: 14/946,124

(22) Filed: Nov. 19, 2015

Related U.S. Application Data
(63) Continuation of application No. PCT/CN2013/076259, filed on May 27, 2013.

(51) Int. Cl. H04W 72/12; H04W 72/04; H04W 76/02; H04W 36/00

(52) U.S. Cl. CPC H04W 72/1268; H04W 36/0005; H04W 72/0406; H04W 76/02

(57) ABSTRACT

The present invention provides a method and an apparatus for transmitting an uplink signal, where the method includes: receiving information that is of a network resource and sent by a scheduling cell, where the scheduling cell is a neighboring cell of a serving cell to which the user equipment belongs; and sending the information of the network resource to the user equipment, so that the user equipment sends the uplink signal by using the network resource. In the method and apparatus for transmitting an uplink signal according to embodiments, the uplink signal is sent by allocating the user equipment with the network resource of the scheduling cell with a small power loss, thereby ensuring quality of the uplink signal as far as possible.

This application is a continuation of International Application No. PCT/CN2013/076259, filed on May 27, 2013, which is hereby incorporated by reference in its entirety.

### TECHNICAL FIELD

The present invention relates to a wireless communications technology, and in particular, to a method and an apparatus for transmitting an uplink signal.

### BACKGROUND

In the prior art, when a user equipment (UE) needs to transmit an uplink signal, the user equipment uses a network resource allocated in advance to transfer the uplink signal to a serving cell to which the user equipment belongs. In the prior art, the network resource is allocated by the serving cell. If there are many user equipments that currently belong to the serving cell, a burden is caused to the serving cell, and it is even possible that the user equipment fails to transmit the uplink signal because no network resource is allocated to the user equipment.

### SUMMARY

Multiple aspects of the present invention provide a method and an apparatus for transmitting an uplink signal, so as to reduce a power loss during uplink signal transmission as far as possible.

A first aspect of the present invention provides a method for transmitting an uplink signal, including:

receiving information that is of a network resource and sent by a scheduling cell, where the scheduling cell is a neighboring cell of a serving cell to which a user equipment belongs; and

sending the information of the network resource to the user equipment, so that the user equipment sends the uplink signal by using the network resource.

With reference to the first aspect, in a first possible implementation manner, before the receiving information that is of a network resource and sent by a scheduling cell, the method further includes:

obtaining a first power loss generated during signal transmission between a serving cell network element of the serving cell to which the user equipment belongs and the user equipment;

obtaining a second power loss generated during signal transmission between a neighboring cell network element of at least one neighboring cell of the serving cell and the user equipment;

determining whether the second power loss is less than the first power loss, and when a determination result is yes, using a cell corresponding to the second power loss as the scheduling cell; and

instructing a scheduling cell network element of the scheduling cell to allocate the user equipment with a network resource for sending the uplink signal.

With reference to the first possible implementation manner, in a second possible implementation manner, before instructing a scheduling cell network element of the scheduling cell to allocate the user equipment with a network resource for sending the uplink signal, the method further includes:

determining whether the first power loss is greater than a first preset threshold, and determining whether the second power loss is less than a second preset threshold, and when determination results are yes, executing the operation of instructing a scheduling cell network element of the scheduling cell to allocate the user equipment with a network resource for sending the uplink signal.

With reference to the second possible implementation manner, in a third possible implementation manner, when multiple second power losses are less than the second preset threshold, a neighboring cell corresponding to the second power loss with a minimum value is used as the scheduling cell.

With reference to the second possible implementation manner or the third possible implementation manner, in a fourth possible implementation manner, before instructing a scheduling cell network element of the scheduling cell to allocate the user equipment with a network resource for sending the uplink signal, the method further includes:

determining whether a difference between the first power loss and the second power loss is greater than a preset threshold value, and when a determination result is yes, executing the operation of instructing a scheduling cell network element of the scheduling cell to allocate the user equipment with a network resource for sending the uplink signal.

With reference to the fourth possible implementation manner, in a fifth possible implementation manner, the method further includes:

when differences between multiple second power losses and the first power loss are less than the preset threshold value, using a cell corresponding to the second power loss with a minimum value as the scheduling cell.

With reference to the first aspect or the first possible implementation manner to the fifth possible implementation manner, in a sixth possible implementation manner, the obtaining a first power loss generated during signal transmission between the serving cell network element to which the user equipment belongs and the user equipment includes:

receiving a DL RSRP, which is sent by the user equipment and obtained through measurement, of the serving cell network element; and

obtaining, according to the DL RSRP of the serving cell network element and a preset downlink reference signal transmit power of the serving cell network element, the first power loss generated during signal transmission between the serving cell network element and the user equipment.

With reference to the first aspect or the first possible implementation manner to the sixth possible implementation manner, in a seventh possible implementation manner, the obtaining a second power loss generated during signal transmission between a neighboring cell network element of at least one neighboring cell of the serving cell and the user equipment includes:

receiving a DL RSRP, which is sent by the user equipment and obtained through measurement, of the neighboring cell network element of the at least one neighboring cell; and

obtaining, according to the DL RSRP of the neighboring cell network element and a preset downlink reference signal transmit power of the neighboring cell network element, the second power loss generated during signal transmission between the neighboring cell network element and the user equipment.

With reference to the first aspect or the first possible implementation manner to the sixth possible implementation manner, in an eighth possible implementation manner, the obtaining a second power loss generated during signal transmission between at least one neighboring cell network element of the serving cell and the user equipment includes:

receiving an SRS received power or a DMRS received power of the user equipment, which is sent by the at least one neighboring cell network element of the serving cell and obtained through measurement by the neighboring cell network element; and

obtaining a power loss generated during signal transmission between the neighboring cell network element and the user equipment according to the SRS received power and a preset SRS transmit power, or obtaining, according to the DMRS received power and a preset DMRS transmit power, a power loss generated during signal transmission between the neighboring cell network element and the user equipment.

With reference to the first aspect or the first possible implementation manner to the eighth possible implementation manner, in a ninth possible implementation manner, the method further includes:

arranging the first power loss and the at least one second power loss in an order from small to large, and selecting cells corresponding to first N power losses as receiving cells, or randomly selecting cells corresponding to N power losses with values less than a third threshold as receiving cells, where N is an integer greater than or equal to 1;

receiving an enhanced uplink signal sent by the user equipment using the network resource via receiving cell network elements of the receiving cells, where the enhanced uplink signal is generated through a COMP operation or a joint transmission operation by the N receiving cell network elements for the uplink signal; and

decoding the enhanced uplink signal, to obtain uplink data.

A second aspect of the present invention provides a method for transmitting an uplink signal, including:

receiving a resource allocation command, which is sent by a serving cell network element of a serving cell to which a user equipment belongs and is used to instruct to allocate the user equipment with a resource for sending the uplink signal; and

allocating, according to the resource allocation command, the user equipment with a network resource for sending the uplink signal.

With reference to the second aspect, in a first possible implementation manner, the method further includes:

sending the information of the network resource to the serving cell network element.

A third aspect of the present invention provides a method for transmitting an uplink signal, including:

receiving information, which is forwarded by a serving cell network element of a serving cell to which a user equipment belongs, of a network resource allocated by a scheduling cell for sending the uplink signal; and

sending the uplink signal according to the information of the network resource;

where the scheduling cell is a neighboring cell of the serving cell with a power loss less than a first power loss of the serving cell network element, the first power loss is a power loss generated during signal transmission between the serving cell network element and the user equipment, and a second power loss is a power loss generated during signal transmission between a neighboring cell network element of at least one neighboring cell of the serving cell and the user equipment.

With reference to the third aspect, in a first possible implementation manner, the method further includes:

receiving information of N receiving cells delivered by the serving cell network element, where N is an integer greater than or equal to 1; and

the sending the uplink signal to the serving cell network element of the serving cell to which the user equipment belongs includes:

sending the uplink signal to receiving cell network elements of the N receiving cells, so that the N receiving cell network elements performs a COMP operation to generate an enhanced uplink signal, and sending the enhanced uplink signal to the serving cell network element.

A fourth aspect of the present invention provides an apparatus for transmitting an uplink signal, including:

an information receiving unit, configured to receive information that is of a network resource and sent by a scheduling cell, where the scheduling cell is a neighboring cell of a serving cell to which a user equipment belongs; and

a first sending unit, configured to send the information of the network resource to the user equipment, so that the user equipment sends the uplink signal by using the network resource.

With reference to the fourth aspect, in a first possible implementation manner, the apparatus further includes:

a first obtaining unit, configured to obtain a first power loss generated during signal transmission between a serving cell network element of the serving cell to which the user equipment belongs and the user equipment;

a second obtaining unit, configured to obtain a second power loss generated during signal transmission between a neighboring cell network element of at least one neighboring cell of the serving cell and the user equipment;

a determining unit, configured to determine whether the second power loss is less than the first power loss, and when a determination result is yes, using a cell corresponding to the second power loss as the scheduling cell; and

a notification unit, configured to instruct a scheduling cell network element of the scheduling cell to allocate the user equipment with a network resource for sending the uplink signal.

With reference to the first possible implementation manner, in a second possible implementation manner, the determining unit is further configured to:

determine whether the first power loss is greater than a first preset threshold, and determine whether the second power loss is less than a second preset threshold, and when determination results are yes, trigger the notification unit.

With reference to the second possible implementation manner, in a third possible implementation manner, the determining unit is further specifically configured to:

when multiple second power losses are less than the second preset threshold, use a neighboring cell corresponding to the second power loss with a minimum value as the scheduling cell.

With reference to the third possible implementation manner, in a fourth possible implementation manner, the determining unit is further configured to:

determine whether a difference between the first power loss and the second power loss is greater than a preset threshold value, and when a determination result is yes, trigger the notification unit.

With reference to the fourth possible implementation manner, in a fifth possible implementation manner, the determining unit is further specifically configured to:

when differences between multiple second power losses and the first power loss are less than the preset threshold value, use a cell corresponding to the second power loss with a minimum value as the scheduling cell.

With reference to the first aspect or the first possible implementation manner to the fifth possible implementation manner, in a sixth possible implementation manner, the first obtaining unit is specifically configured to:

receive a DL RSRP, which is sent by the user equipment and obtained through measurement, of the serving cell network element; and

obtain, according to the DL RSRP of the serving cell network element and a preset downlink reference signal transmit power of the serving cell network element, the first power loss generated during signal transmission between the serving cell network element and the user equipment.

With reference to the first aspect or the first possible implementation manner to the sixth possible implementation manner, in a seventh possible implementation manner, the second obtaining unit is specifically configured to:

receive a DL RSRP, which is sent by the user equipment and obtained through measurement, of the neighboring cell network element of the at least one neighboring cell; and

obtain, according to the DL RSRP of the neighboring cell network element and a preset downlink reference signal transmit power of the neighboring cell network element, the second power loss generated during signal transmission between the neighboring cell network element and the user equipment.

With reference to the first aspect or the first possible implementation manner to the sixth possible implementation manner, in an eighth possible implementation manner, the second obtaining unit is specifically configured to:

receive an SRS received power or a DMRS received power of the user equipment, which is sent by at least one neighboring cell network element of the serving cell and obtained through measurement by the neighboring cell network element; and

obtain a power loss generated during signal transmission between the neighboring cell network element and the user equipment according to the SRS received power and a preset SRS transmit power, or obtain, according to the DMRS received power and a preset DMRS transmit power, a power loss generated during signal transmission between the neighboring cell network element and the user equipment.

With reference to the first aspect or the first possible implementation manner to the eighth possible implementation manner, in a ninth possible implementation manner, the apparatus further includes:

a selecting unit, configured to arrange the first power loss and the at least one second power loss in an order from small to large, and select cells corresponding to first N power losses as receiving cells, or randomly select cells corresponding to N power losses with values less than a third threshold as receiving cells, where N is an integer greater than or equal to 1;

a first receiving unit, configured to receive an enhanced uplink signal sent by the user equipment using the network resource via receiving cell network elements of the receiving cells, where the enhanced uplink signal is generated through a COMP operation or a joint transmission operation by the N receiving cell network elements for the uplink signal; and

a resolving unit, configured to decode the enhanced uplink signal, to obtain uplink data.

A fifth aspect of the present invention provides an apparatus for transmitting an uplink signal, including:

a second receiving unit, configured to receive a resource allocation command, which is sent by a serving cell network element of a serving cell to which a user equipment belongs and is used to instruct to allocate the user equipment with a resource for sending the uplink signal; and

a second allocating unit, configured to allocate, according to the resource allocation command, the user equipment with a network resource for sending the uplink signal.

With reference to the fifth aspect, in a first possible implementation manner, the apparatus further includes:

a second sending unit, configured to send information of the network resource to the serving cell network element.

A sixth aspect of the present invention provides an apparatus for transmitting an uplink signal, including:

a third receiving unit, configured to receive information, which is forwarded by a serving cell network element of a serving cell to which a user equipment belongs, of a network resource allocated by a scheduling cell for sending the uplink signal, where the scheduling cell is a neighboring cell of the serving cell with a power loss less than a first power loss of the serving cell network element, the first power loss is a power loss generated during signal transmission between the serving cell network element and the user equipment, and the second power loss is a power loss generated during signal transmission between a neighboring cell network element of at least one neighboring cell of the serving cell and the user equipment; and

a third sending unit, configured to send the uplink signal according to the information of the network resource.

With reference to the sixth aspect, in a first possible implementation manner, the third receiving unit is further configured to receive information of N receiving cells delivered by the serving cell network element, where N is an integer greater than or equal to 1; and

the third sending unit is specifically configured to:

send the uplink signal to receiving cell network elements of the N receiving cells according to the information of the network resource of the uplink signal, so that the N receiving cell network elements performs a COMP operation to generate an enhanced uplink signal, and send the enhanced uplink signal to the serving cell network element.

A seventh aspect of the present invention provides an apparatus for transmitting an uplink signal, including: at least one first processor and a first memory, the first memory being configured to store an executable program code, where the first processor runs a program corresponding to the executable program code by reading an executable program code stored in the first memory, so as to be configured to:

receive information that is of a network resource and sent by a scheduling cell, where the scheduling cell is a neighboring cell of a serving cell to which a user equipment belongs; and

send the information of the network resource to the user equipment, so that the user equipment sends the uplink signal by using the network resource.

An eighth aspect of the present invention provides an apparatus for transmitting an uplink signal, including: at least one second processor and a second memory, the second memory being configured to store an executable program code, where the second processor runs a program corresponding to the executable program code by reading an executable program code stored in the second memory, so as to be configured to:

receive a resource allocation command, which is sent by a serving cell network element of a serving cell to which a user equipment belongs and is used to instruct to allocate the user equipment with a resource for sending the uplink signal; and

allocate, according to the resource allocation command, the user equipment with a network resource for sending the uplink signal.

A ninth aspect of the present invention provides an apparatus for transmitting an uplink signal, including: at least one third processor and a third memory, the third memory being configured to store an executable program code, where the third processor runs a program corresponding to the executable program code by reading an executable program code stored in the third memory, so as to be configured to:

receive information, which is forwarded by a serving cell network element of a serving cell to which a user equipment belongs, of a network resource allocated by a scheduling cell for sending the uplink signal; and

send the uplink signal according to the information of the network resource;

where the scheduling cell is a neighboring cell of the serving cell with a power loss less than a first power loss of the serving cell network element, the first power loss is a power loss generated during signal transmission between the serving cell network element and the user equipment, and the second power loss is a power loss generated during signal transmission between a neighboring cell network element of at least one neighboring cell of the serving cell and the user equipment.

In the method and apparatus for transmitting an uplink signal according to the embodiments, the uplink signal is sent by using the network resource of the neighboring cell of the serving cell, which can lighten a network burden of the serving cell, thereby ensuring fluency of signal transmission of the user equipment as far as possible.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1A is a schematic flowchart of a method for transmitting an uplink signal according to an embodiment of the present invention;

FIG. 1B is a schematic flowchart of a method for transmitting an uplink signal according to another embodiment of the present invention;

FIG. 1C(a) and FIG. 1C(b) are a schematic flowchart of a method for transmitting an uplink signal according to still another embodiment of the present invention;

FIG. 2 is a schematic flowchart of a method for transmitting an uplink signal according to yet another embodiment of the present invention;

FIG. 3 is a schematic flowchart of a method for transmitting an uplink signal according to still another embodiment of the present invention;

FIG. 4 is a schematic flowchart of a method for transmitting an uplink signal according to yet another embodiment of the present invention;

FIG. 5A is a schematic structural diagram of an apparatus for transmitting an uplink signal according to still another embodiment of the present invention;

FIG. 5B is a schematic structural diagram of an apparatus for transmitting an uplink signal according to yet another embodiment of the present invention;

FIG. 6 is a schematic structural diagram of an apparatus for transmitting an uplink signal according to another embodiment of the present invention;

FIG. 7A is a schematic structural diagram of an apparatus for transmitting an uplink signal according to yet another embodiment of the present invention;

FIG. 7B is a schematic structural diagram of an apparatus for transmitting an uplink signal according to still another embodiment of the present invention; and

FIG. 8 is a schematic structural diagram of an apparatus for transmitting an uplink signal according to another embodiment of the present invention.

### DETAILED DESCRIPTION OF ILLUSTRATIVE EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are a part rather than all of the embodiments of the present invention. All other embodiments obtained by persons of ordinary skill in the art based on the embodiments of the present invention without creative efforts shall fall within the protection scope of the present invention.

In the embodiments of the present invention, a cell to which a user equipment (UE) currently belongs is referred to as a “serving cell.”

### Embodiment 1

This embodiment provides a method for transmitting an uplink signal, the method for transmitting an uplink signal is applicable to a wireless communications network, and is particularly applicable to a network that can perform a coordinated multi-point transmission/reception (COMP) operation. In this embodiment, an apparatus for transmitting an uplink signal may execute the method for transmitting an uplink signal, the apparatus for transmitting an uplink signal may be integrated in a serving cell network element of a serving cell, and the serving cell network element may specifically be a base station.

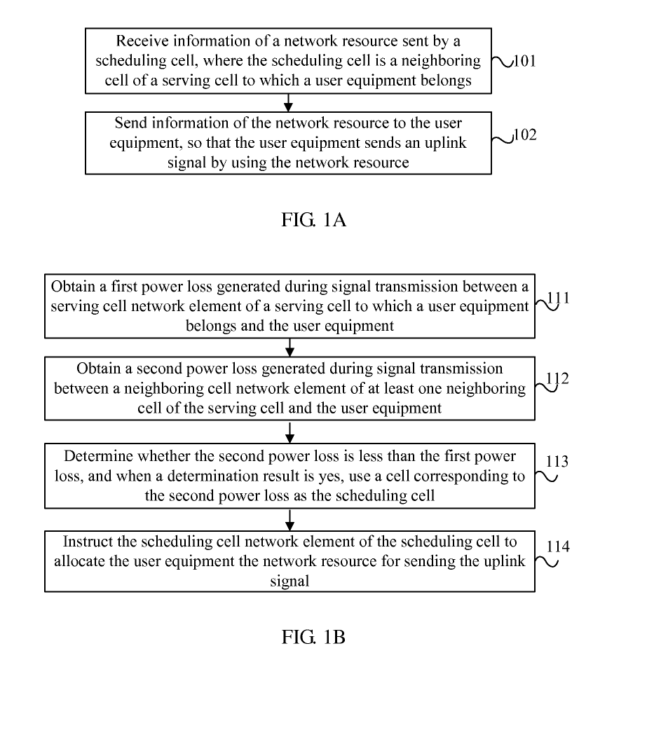

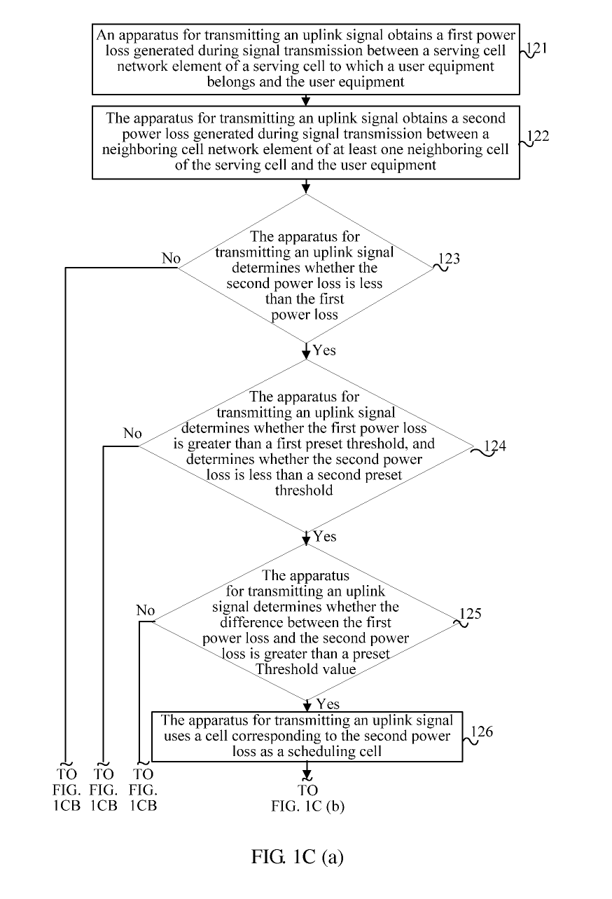

FIG. 1A is a schematic flowchart of a method for transmitting an uplink signal according to this embodiment.

Step 101: Receive information that is of a network resource and sent by a scheduling cell, where the scheduling cell is a neighboring cell of a serving cell to which a user equipment belongs.

In this embodiment, a cell to which the user equipment belongs is referred to as a “serving cell,” and a network side device in the serving cell is referred to as a “serving cell network element.” The scheduling cell is a neighboring cell of the serving cell. The information of the network resource may include an identifier of the user equipment.

Step 102: Send the information of the network resource to the user equipment, so that the user equipment sends the uplink signal by using the network resource.

After receiving the information, which is sent by the user equipment, of the network resource allocated by the scheduling cell to the user equipment, the apparatus for transmitting an uplink signal sends the information of the network resource to a corresponding user equipment.

After receiving the information of the network resource, the user equipment sends, according to a frequency, a power, a modulation manner, transmission resource block information or hybrid automatic repeat request (HARQ) information, which are carried in the network resource, the uplink signal to the serving cell network element by using the network resource, where the uplink signal carries service data of the user equipment.

In the method for transmitting an uplink signal according to this embodiment, the uplink signal is sent by using the network resource of the neighboring cell of the serving cell, which can lighten a network burden of the serving cell, thereby ensuring fluency of signal transmission of the user equipment as far as possible.

Optionally, as shown in FIG. 1B, before step 101, the method further includes:

Step 111: Obtaining a first power loss generated during signal transmission between the serving cell network element of the serving cell to which the user equipment belongs and the user equipment.

There are many methods for the apparatus for transmitting an uplink signal to obtain the first power loss of the serving cell, for example:

receiving a DL RSRP, which is sent by the user equipment and obtained through measurement, of the serving cell network element; and

obtaining, according to the DL RSRP of the serving cell network element and a preset downlink reference signal transmit power of the serving cell network element, the first power loss generated during signal transmission between the serving cell network element and the user equipment.

The user equipment may obtain through measurement the DL RSRP of the serving cell network element, and then send the DL RSRP of the serving cell network element to the apparatus for transmitting an uplink signal. The downlink reference signal transmit power of the serving cell network element may be preset in a reference table, where the reference table may include the downlink reference signal transmit power of the serving cell network element and downlink reference signal transmit powers of neighboring cell network elements of each neighboring cell. When needing to obtain the downlink reference signal transmit powers of each neighboring cell network element, the apparatus for transmitting an uplink signal queries the reference table, and specifically may obtain the corresponding downlink reference signal transmit power by using identification information of each neighboring cell network element. The reference table may be stored in the serving cell network element or be stored separately, as long as the apparatus for transmitting an uplink signal can obtain the reference table. For example, the neighboring cell network element sends the downlink reference signal transmit power of its own to the serving cell network element.

In addition, the apparatus for transmitting an uplink signal may obtain through measurement an sounding reference signal (SRS) received power of the user equipment or a demodulation reference signal (DMRS) received power of the user equipment. The first power loss generated during signal transmission between the serving cell network element and the user equipment is obtained according to the SRS received power and a preset SRS transmit power, or the first power loss generated during signal transmission between the serving cell network element and the user equipment is obtained according to the DMRS received power and a preset DMRS transmit power.

The power loss in each embodiment is specifically a power loss generated in an air interface link from the serving cell network element to the user equipment.

Step 112: Obtaining a second power loss generated during signal transmission between a neighboring cell network element of at least one neighboring cell of the serving cell and the user equipment.

The neighboring cell network element may specifically be a base station.

There are many manners for the apparatus for transmitting an uplink signal to obtain the second power loss, and in this embodiment, the following examples are given.

Manner 1: Receiving a DL RSRP, which is sent by the user equipment and obtained through measurement, of the neighboring cell network element of the at least one neighboring cell; and

obtaining, according to the DL RSRP of the neighboring cell network element and a preset downlink reference signal transmit power of the neighboring cell network element, the second power loss generated during signal transmission between the neighboring cell network element and the user equipment.

In Manner 1, the user equipment measures DL RSRPs of each neighboring cell network element of the serving cell, and sends the DL RSRPs to the apparatus for transmitting an uplink signal, and the apparatus for transmitting an uplink signal looks up the reference table to obtain downlink reference signal transmit powers of each neighboring cell network element. A difference between the downlink reference signal transmit power of the neighboring cell network element and the DL RSRP of the neighboring cell network element is calculated, and the difference is the second power loss during signal transmission between the neighboring cell network element and the user equipment. That is to say, a second power loss during signal transmission between a certain neighboring cell network element and the user equipment is equal to a result of subtracting the DL RSRP of the neighboring cell network element from the downlink reference signal transmit power of the neighboring cell network element.

Second manner: Receiving the SRS received power or the DMRS received power of the user equipment, which is sent by at least one neighboring cell network element of the serving cell and obtained through measurement by the neighboring cell network element; and

obtaining the second power loss generated during signal transmission between the neighboring cell network element and the user equipment according to the SRS received power and the preset SRS transmit power, or obtain, according to the DMRS received power and the preset DMRS transmit power, the second power loss generated during signal transmission between the neighboring cell network element and the user equipment.

In Manner 2, the neighboring cell network element measures an SRS or a DMRS of the user equipment, and obtains the SRS received power or the DMRS received power. Then, the neighboring cell network element sends the obtained SRS received power or DMRS received power to a serving network element. The serving network element subtracts the preset SRS received power from the SRS transmit power to obtain the second power loss generated during signal transmission between the neighboring cell network element and the user equipment, or subtracts the DMRS received power from the DMRS transmit power to obtain the second power loss generated during signal transmission between the neighboring cell network element and the user equipment. The SRS transmit power and the DMRS transmit power may be maintained in the serving cell network element. That is to say, the serving cell network element may obtain the SRS transmit power or the DMRS transmit power from a maintained user equipment parameter list.

It should be noted that, an order of step 111 and step 112 may be reversed. That is to say, no sequence is set for operations of step 111 and step 112.

Step 113: Determine whether the second power loss is less than the first power loss, and when a determination result is yes, use a cell corresponding to the second power loss as the scheduling cell.

When the determination result of step 113 is no, the serving cell network element allocates the user equipment with a network resource for sending the uplink signal.

In the step, the apparatus for sending an uplink signal first compares the first power loss with the obtained second power loss, and when identifying that the second power loss is less than the first power loss, the apparatus may select a cell corresponding to the second power loss with a value less than the first power loss as the scheduling cell.

Specifically, whether one of the following conditions is met or all of the conditions are met may further be determined:

A: Determining whether the first power loss is greater than a first preset threshold, and determine whether the second power loss is less than a second preset threshold, and when determination results are yes, execute step 104, and when determination results are no, use the serving cell as the scheduling cell.

The step A may be before or after step 113, and the details are not limited. It should be noted that, when it is determined that multiple second power losses are less than the first power loss and less than the second preset threshold, a cell corresponding to one second power loss may be randomly selected as the scheduling cell, or a cell corresponding to the second power loss with a minimum value is selected as the scheduling cell. The first preset threshold and the second preset threshold may be set according to actual requirements. The purpose of the step is to prevent frequently switching scheduling cells, thereby avoiding increasing a network burden.

B: Determining whether a difference between the first power loss and the second power loss is greater than a preset threshold value, and when a determination result is yes, execute the operation of instructing a scheduling cell network element of the scheduling cell to allocate the user equipment with a network resource for sending the uplink signal.

The step B may be before or after step 113, may also be performed together with the step A, and the details are not limited. It should be noted that, when differences between multiple second power losses and the first power loss are less than the preset threshold value, a cell corresponding to one second power loss may be randomly selected as the scheduling cell, or a cell corresponding to the second power loss with a minimum value is selected as the scheduling cell. The first preset threshold and the second preset threshold may be set according to actual requirements. The purpose of the step is to prevent frequently switching scheduling cells, thereby avoiding increasing a network burden.

The preset threshold value of this embodiment may be set according to actual requirements, for example, 0 dB, 3 dB, 6 dB, or 9 dB.

Step 114: Instruct the scheduling cell network element of the scheduling cell to allocate the user equipment with the network resource for sending the uplink signal.

The network resource of this embodiment may be a time-frequency resource. Specifically, the apparatus for transmitting an uplink signal may send a resource allocation command to the scheduling cell network element, where the resource allocation command may include identification information of a terminal device, for example, a user equipment identifier (UEID) of the terminal device. Then, the scheduling cell network element executes the operation of allocating the user equipment with the network resource for sending the uplink signal.

In this embodiment, by comparing values of the first power loss and the at least one second power loss, the cell corresponding to the power loss with the minimum value is selected to allocate the user equipment with the network resource for sending the uplink signal, so that the user equipment sends the uplink signal to the serving cell network element to which the user equipment belongs by using the allocated network resource, which can reduce the power loss of the uplink signal, thereby ensuring quality of the uplink signal as far as possible.

### Embodiment 2

This embodiment further supplements and describes the method for transmitting an uplink signal of Embodiment 1.

The method for transmitting an uplink signal of this embodiment further includes:

arranging the first power loss and the at least one second power loss in an order from small to large, and selecting cells corresponding to first N power losses as N receiving cells, or randomly selecting cells corresponding to N power losses with values less than a third threshold as receiving cells, where N is an integer greater than or equal to 1;

receiving an enhanced uplink signal sent by the user equipment using the network resource via receiving cell network elements of the N receiving cells, where the enhanced uplink signal is generated through a COMP operation by N receiving cell network elements for the uplink signal; and

decoding the enhanced uplink signal, to obtain uplink data.

The apparatus for transmitting an uplink signal arranges the serving cell and the neighboring cells in an order of power losses from small to large, selects the first N cells as the receiving cells, or randomly selects the cells corresponding to the N power losses with values less than the third preset threshold as the receiving cells, where the third preset threshold may be set according to actual requirements. It should be noted that, when the number of cells corresponding to the power losses with values less than the third preset threshold is less than N, all cells corresponding to the power losses with values less than the third preset threshold are used as the receiving cells. That is to say, when N>H, H cells corresponding to the power losses with values less than the third preset threshold are randomly selected as the receiving cells, where H is the number of cells corresponding to the power losses with values less than the third preset threshold, and H is greater than or equal to 1. The N receiving cells may perform the COMP operation. The COMP operation specifically improves system performance through cooperation among multiple network elements. For example, joint reception, joint transmission and joint scheduling are performed among the multiple network elements. That is to say, in the COMP technology, multiple cell network elements may simultaneously serve one user equipment or network element in a joint processing manner, to improve strength of the signal received by the user equipment or the network element, thereby improving transmission efficiency.

Specifically, the apparatus for transmitting an uplink signal sends information of N receiving cells to the user equipment, the user equipment sends the uplink signal simultaneously to the receiving cell network elements of the N receiving cells by using allocated network resources. The receiving cell network elements of the N receiving cells perform the COMP operation, which may specifically be a joint reception operation, for uplink signals sent for the receiving cell network elements, to generate an enhanced uplink signal, so as to improve reception quality of the uplink signals. Specifically, how to perform the COMP operation to generate the enhanced uplink signal belongs to the prior art, and details will not be described herein again. The apparatus for transmitting an uplink signal receives the enhanced uplink signal, to obtain the uplink data.

It should be noted that, the serving cell may be the scheduling cell, the apparatus for transmitting an uplink signal of this embodiment can execute the operation of the scheduling cell network element, and the serving cell may also be the receiving cell. In this way, the apparatus for transmitting an uplink signal of this embodiment can execute the operation of the receiving cell network element. Therefore, the user equipment sending the uplink signal to the serving cell network element may be directly sending the uplink signal to the serving cell network element, or indirectly sending the uplink signal via other network elements, which is not limited in this embodiment.

Therefore, optionally, when the serving cell itself is the scheduling cell, the method for transmitting an uplink signal of this embodiment further includes an operation of allocating the network resource to the user equipment. At this time, the apparatus for transmitting an uplink signal receives the information that is of the network resource and sent by the serving cell network element.

In the method for transmitting an uplink signal of this embodiment, the scheduling cell network element is used to allocate the network resource to the user equipment, so that the user equipment sends the uplink signal to the N receiving cells by using the network resource. Therefore, the N receiving cells perform the COMP operation to generate the enhanced uplink signal and send the enhanced uplink signal to the serving cell network element, so that the serving cell network element obtains the uplink data by decoding the enhanced uplink signal, thereby further ensuring quality of the uplink signal and improving efficiency of uplink signal transmission.

### Embodiment 3

Based on the foregoing embodiments, this embodiment provides a method for transmitting an uplink signal.

FIG. 1C(a) and FIG. 1C(b) are a schematic flowchart of a method for transmitting an uplink signal according to this embodiment.

Step 121: An apparatus for transmitting an uplink signal obtains a first power loss generated during signal transmission between a serving cell network element of a serving cell to which a user equipment belongs and the user equipment, and the process turns to step 122.

Step 122: The apparatus for transmitting an uplink signal obtains a second power loss generated during signal transmission between a neighboring cell network element of at least one neighboring cell of the serving cell and the user equipment, and the process turns to step 123.

Step 123: The apparatus for transmitting an uplink signal determines whether the second power loss is less than the first power loss, and when a determination result is yes, the process turns to step 124, and when a determination result is no, the process turns to step 129.

Step 124: The apparatus for transmitting an uplink signal determines whether the first power loss is greater than a first preset threshold, and determines whether the second power loss is less than a second preset threshold, and when determination results are yes, the process turns to step 125, and when determination results are no, the process turns to step 129.

Specifically, the step may be only determining whether the second power loss with a value less than the first power loss is less than the second preset threshold.

Step 125: The apparatus for transmitting an uplink signal determines whether the difference between the first power loss and the second power loss is greater than a preset threshold value, and when a determination result is yes, the process turns to step 126, and when a determination result is no, the process turns to step 129.

Specifically, the step may be only determining whether the difference between the second power loss with a value less than the second preset threshold and the first power loss is greater than the preset threshold value.

Step 126: The apparatus for transmitting an uplink signal uses a cell corresponding to the second power loss as a scheduling cell, and the process turns to step 127.

Step 127: The apparatus for transmitting an uplink signal instructs a scheduling cell network element of the scheduling cell to allocate the user equipment with a network resource for sending the uplink signal, and the process turns to step 128.

Step 128: The scheduling cell network element sends information of the allocated network resource to the apparatus for transmitting an uplink signal, and the process turns to step 130.

Step 129: The apparatus for transmitting an uplink signal allocates the user equipment with a network resource for sending the uplink signal, and the process turns to step 130.

Step 130: The apparatus for transmitting an uplink signal sends the information of the network resource for sending the uplink signal to the user equipment, and the process turns to step 131.

Step 131: The apparatus for transmitting an uplink signal selects cells corresponding to N power losses with values less than a third preset threshold as receiving cells, and sends information of the receiving cells to the user equipment, and the process turns to step 132.

Step 132: N receiving cell network elements perform COMP operation for the uplink signal sent by the user equipment, to generate an enhanced uplink signal, and sends the enhanced uplink signal to the apparatus for transmitting an uplink signal, and the process turns to step 133.

Step 133: The apparatus for transmitting an uplink signal receives the enhanced uplink signal, and decodes the enhanced uplink signal, to obtain uplink data.

### Embodiment 4

This embodiment provides a method for transmitting an uplink signal, and the method for transmitting an uplink signal is applicable to a network that performs COMP. In this embodiment, an apparatus for transmitting an uplink signal may execute the method for transmitting an uplink signal, and the apparatus for transmitting an uplink signal may be integrated in a scheduling cell network element of a scheduling cell. The specific method for determining the scheduling cell may be consistent with that in Embodiment 1 or Embodiment 2 or Embodiment 3, and details will not be described herein again.

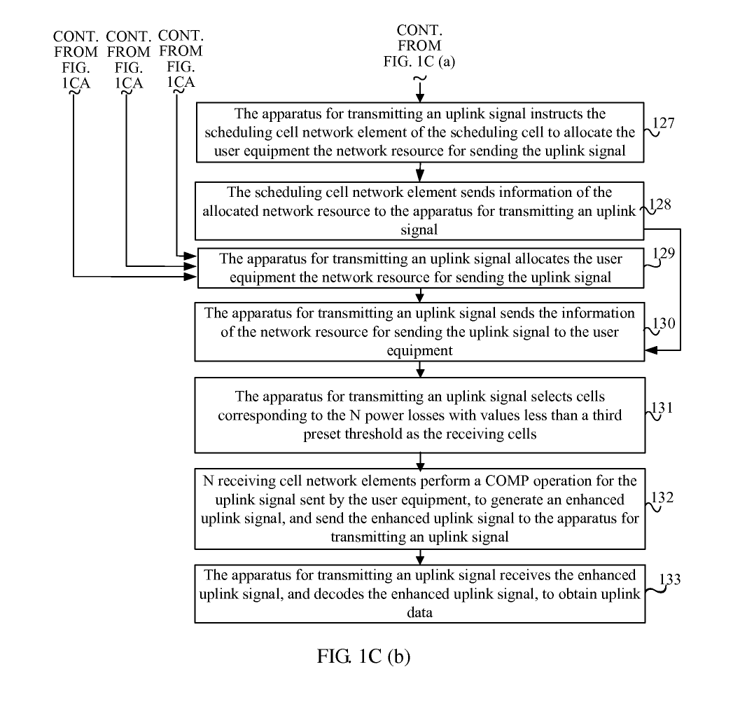

FIG. 2 is a schematic flowchart of a method for transmitting an uplink signal according to this embodiment.

Step 201: Receive a resource allocation command, which is sent by a serving cell network element of a serving cell to which a user equipment belongs and is used to instruct to allocate the user equipment with a resource for sending the uplink signal.

The operation of the serving cell network element of this embodiment may be the same as that of Embodiment 1 or Embodiment 2 or Embodiment 3. The resource allocation command may include information of the user equipment.

Step 202: Allocate, according to the resource allocation command, the user equipment with a network resource for sending the uplink signal.

After receiving the resource allocation command, the apparatus for transmitting an uplink signal allocates the user equipment with the network resource for sending the uplink signal.

In the method for transmitting an uplink signal according to this embodiment, the apparatus for transmitting an uplink signal at the scheduling cell allocates the user equipment with the network resource for sending the uplink signal, which can lighten a burden of the serving cell network element, thereby ensuring fluency of signal transmission of the user equipment as far as possible.

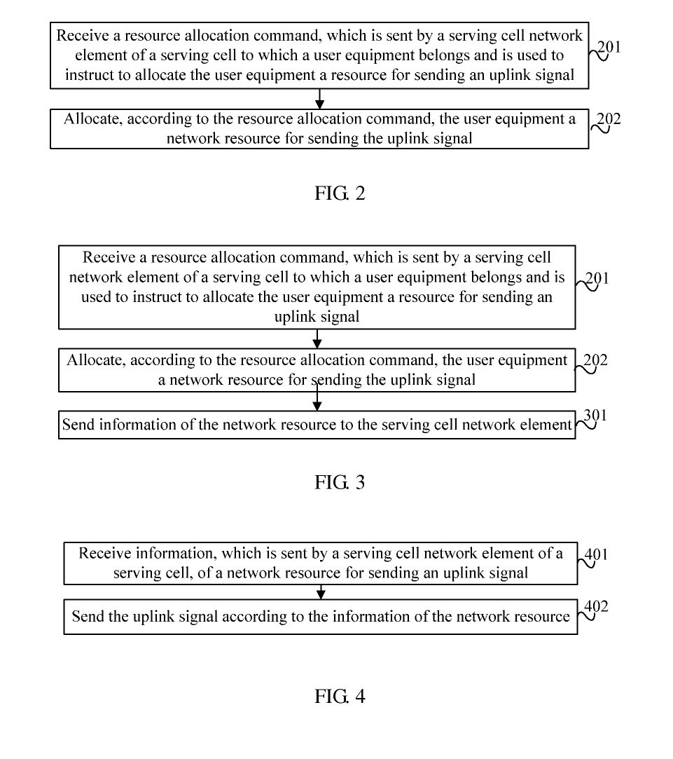

Optionally, as shown in FIG. 3, the method for transmitting an uplink signal of this embodiment further includes:

Step 301: Sending information of the network resource to the serving cell network element.

After finishing the operation of allocating the network resource, the apparatus for transmitting an uplink signal sends the information of the allocated network resource to the serving cell network element. After receiving the information of the network resource, the serving cell network element sends the information of the network resource to the user equipment according to information of the user equipment included in the information of the network resource. Specifically, the network resource may be a time-frequency resource.

### Embodiment 5

This embodiment provides a method for transmitting an uplink signal, and the method for transmitting an uplink signal is applicable to a wireless communications network, and is particularly applicable to a network that performs COMP. In this embodiment, an apparatus for transmitting an uplink signal may execute the method for transmitting an uplink signal, and the apparatus for transmitting an uplink signal may be integrated in a user equipment.

FIG. 4 is a schematic flowchart of a method for transmitting an uplink signal according to this embodiment.

Step 401: Receive information, which is sent by a serving cell network element of a serving cell, of a network resource for sending the uplink signal.

A scheduling cell is a neighboring cell of the serving cell with a power loss less than a first power loss of the serving cell network element, the first power loss is a power loss generated during signal transmission between the serving cell network element and the user equipment, and a second power loss is a power loss generated during signal transmission between a neighboring cell network element of at least one neighboring cell of the serving cell and the user equipment.

A more specific manner of selecting the scheduling cell and how the scheduling cell allocates the network resource to the apparatus for transmitting an uplink signal are consistent with those in the above embodiments, and details will not be described herein again. The information of the network resource may be time-frequency resource information, and the apparatus for transmitting an uplink signal sends the uplink signal according to the time-frequency resource information, and details will not be described herein again.

Step 402: Send the uplink signal according to the information of the network resource.

Specifically, the apparatus for transmitting an uplink signal may send the uplink signal to the serving cell network element of the serving cell to which the user equipment belongs.

The apparatus for transmitting an uplink signal may send the uplink signal to the serving cell network element by forwarding by a receiving cell network element.

Specifically, information of N receiving cells delivered by the serving cell network element to the user equipment is received, where N is an integer greater than or equal to 1. Then, step 402 may specifically include:

sending the uplink signal to receiving cell network elements of the N receiving cells, so that the N receiving cell network elements perform a COMP operation to generate an enhanced uplink signal, and sending the enhanced uplink signal to the serving cell network element.

Specifically, how the receiving cell network element performs the COMP operation belongs to the prior art, and details will not be described herein again. After receiving the enhanced uplink signal, the serving cell network element may perform a decoding operation for the enhanced uplink signal, to obtain uplink data.

In the method for transmitting an uplink signal according to this embodiment, the apparatus for transmitting an uplink signal sends the uplink signal by using the network resource allocated by the scheduling cell network element, which can lighten a burden of the serving cell network element, thereby ensuring fluency of signal transmission of the user equipment as far as possible.

Persons of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes any medium that can store program code, such as a ROM, a RAM, a magnetic disk, or an optical disc.

### Embodiment 6

This embodiment provides an apparatus for transmitting an uplink signal, for executing the method for transmitting an uplink signal of Embodiment 1. The apparatus for transmitting an uplink signal may be integrated in a serving cell network element of a serving cell, and the serving cell network element may specifically be a base station.

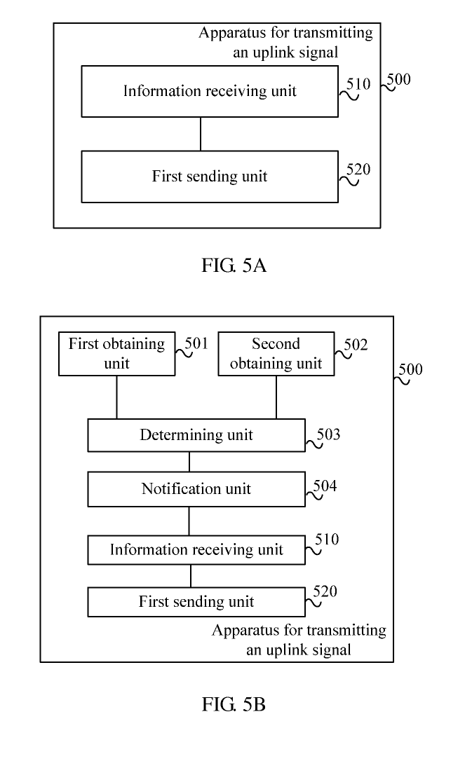

FIG. 5A is a schematic structural diagram of an apparatus for transmitting an uplink signal according to this embodiment. The apparatus 500 for transmitting an uplink signal specifically includes an information receiving unit 510 and a first sending unit 520.

The information receiving unit 510 is configured to receive information that is of a network resource and sent by a scheduling cell, where the scheduling cell is a neighboring cell of a serving cell to which a user equipment belongs. The first sending unit 520 is configured to send the information of the network resource received by the information receiving unit 510 to the user equipment, so that the user equipment sends the uplink signal by using the network resource.

The specific operating manner of the apparatus 500 for transmitting an uplink signal is consistent with the method shown in FIG. 1A, and details will not be described herein again.

Optionally, as shown in FIG. 5B, the apparatus 500 for transmitting an uplink signal of this embodiment further includes a first obtaining unit 501, a second obtaining unit 502, a determining unit 503, and a notification unit 504.

The first obtaining unit 501 is configured to obtain a first power loss generated during signal transmission between a serving cell network element of the serving cell to which the user equipment belongs and the user equipment. The second obtaining unit 502 is configured to obtain a second power loss generated during signal transmission between a neighboring cell network element of at least one neighboring cell of the serving cell and the user equipment. The determining unit 503 is configured to determine whether the second power loss obtained by the second obtaining unit 502 is less than the first power loss obtained by the first obtaining unit 501, and when a determination result is yes, use a cell corresponding to the second power loss as the scheduling cell. The notification unit 504 is configured to instruct a scheduling cell network element of the scheduling cell determined by the determining unit 503 to allocate the user equipment with a network resource for sending the uplink signal.

Optionally, the determining unit 503 is further configured to determine whether the first power loss is greater than a first preset threshold, and determine whether the second power loss is less than a second preset threshold, and when determination results are yes, trigger the notification unit 504. The determining unit 503 may be further configured to: when multiple second power losses are less than the second preset threshold, use a neighboring cell corresponding to the second power loss with a minimum value as the scheduling cell.

The determining unit 503 is further configured to determine whether a difference between the first power loss and the second power loss is greater than a preset threshold value, and when a determination result is yes, trigger the notification unit 504. The determining unit 503 is further configured to: when differences between multiple second power losses and the first power loss are less than the preset threshold value, use a cell corresponding to the second power loss with a minimum value as the scheduling cell.

Optionally, the first obtaining unit 501 is specifically configured to:

receive a DL RSRP, which is sent by the user equipment and obtained through measurement, of the serving cell network element; and

obtain, according to the DL RSRP of the serving cell network element and a preset downlink reference signal transmit power of the serving cell network element, the first power loss generated during signal transmission between the serving cell network element and the user equipment.

Optionally, the second obtaining unit 502 is specifically configured to receive a DL RSRP, which is sent by the user equipment and obtained through measurement, of the neighboring cell network element of at least one neighboring cell; and obtain, according to the DL RSRP of the neighboring cell network element and a preset downlink reference signal transmit power of the neighboring cell network element, the second power loss generated during signal transmission between the neighboring cell network element and the user equipment. Alternatively, the second obtaining unit 502 is specifically configured to receive an SRS received power of the user equipment or a DMRS received power of the user equipment, which is sent by at least one neighboring cell network element of the serving cell and obtained through measurement by the neighboring cell network element; and obtain a power loss generated during signal transmission between the neighboring cell network element and the user equipment according to the SRS received power and a preset SRS transmit power, or obtain, according to the DMRS received power and a preset DMRS transmit power, a power loss generated during signal transmission between the neighboring cell network element and the user equipment.

The specific operating method of the apparatus 500 for transmitting an uplink signal of this embodiment is consistent with that in Embodiment 1, and details will not be described herein again.

In this way, by comparing values of the first power loss and the at least one second power loss, the apparatus 500 for transmitting an uplink signal selects the cell corresponding to the power loss with the minimum value to allocate the user equipment with the network resource for sending the uplink signal, so that the user equipment sends the uplink signal to the serving cell network element to which the user equipment belongs by using the allocated network resource, which can reduce the power loss of the uplink signal, thereby ensuring quality of the uplink signal as far as possible.

### Embodiment 7

This embodiment provides an apparatus 500 for transmitting an uplink signal provided based on Embodiment 1, and is used to execute the method for transmitting an uplink signal of Embodiment 2.

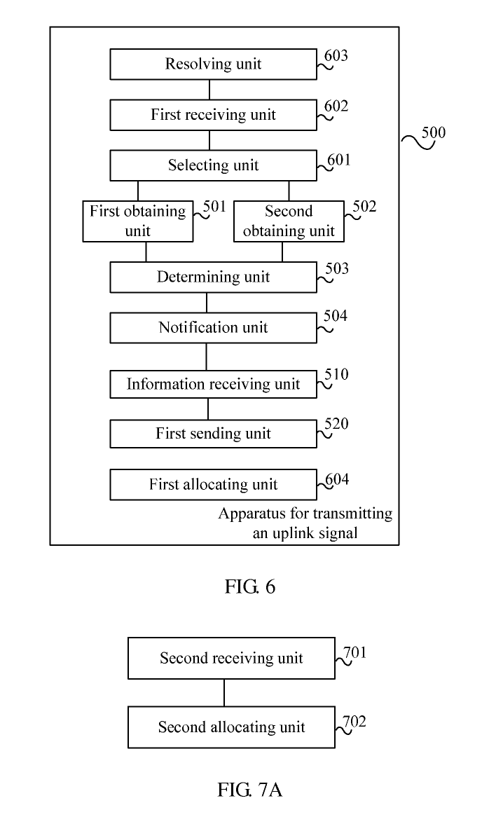

As shown in FIG. 6, the apparatus 500 for transmitting an uplink signal of this embodiment further includes a selecting unit 601, a first receiving unit 602, and a resolving unit 603.

The selecting unit 601 is configured to arrange the first power loss obtained by the first obtaining unit 501 and the at least one second power loss obtained by the second obtaining unit 502 in an order from small to large, and select cells corresponding to first N power losses as receiving cells, or randomly select cells corresponding to N power losses with values less than a third threshold as receiving cells, where N is an integer greater than or equal to 1. The first receiving unit 602 is configured to receive an enhanced uplink signal sent by the user equipment using the network resource via receiving cell network elements of the receiving cells selected by the selecting unit 601, where the enhanced uplink signal is generated through a COMP operation or a joint transmission operation by the N receiving cell network elements for the uplink signal. The resolving unit 603 is configured to decode the enhanced uplink signal received by the first receiving unit 602, to obtain uplink data.

The apparatus 500 for transmitting an uplink signal of this embodiment further includes a first allocating unit 604. When the serving cell is the scheduling cell, the first allocating unit 604 is configured to allocate a time-frequency resource to the user equipment, where the time-frequency resource may be sent to the user equipment by using the first sending unit 520.

The specific operating method of the apparatus 500 for transmitting an uplink signal of this embodiment is consistent with that in Embodiment 2, and details will not be described herein again.

In the apparatus 500 for transmitting an uplink signal of this embodiment, the scheduling cell network element is used to allocate the network resource to the user equipment, so that the user equipment sends the uplink signal to the N receiving cells by using the network resource. Therefore, the N receiving cells perform the COMP operation to generate the enhanced uplink signal and send the enhanced uplink signal to the serving cell network element, so that the serving cell network element obtains the uplink data by decoding the enhanced uplink signal, thereby further ensuring quality of the uplink signal and improving efficiency of uplink signal transmission.

### Embodiment 8

This embodiment provides an apparatus for transmitting an uplink signal, for executing the method for transmitting an uplink signal of Embodiment 4. The apparatus for transmitting an uplink signal may specifically be integrated in a scheduling cell network element of a scheduling cell. The specific method for determining the scheduling cell may be consistent with that in the foregoing embodiments, and details will not be described herein again.

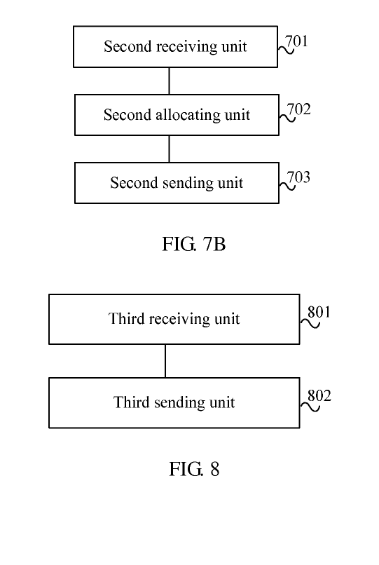

FIG. 7A is a schematic structural diagram of an apparatus for transmitting an uplink signal according to this embodiment. The apparatus for transmitting an uplink signal includes a second receiving unit 701 and a second allocating unit 702.

The second receiving unit 701 is configured to receive a resource allocation command, which is sent by a serving cell network element of a serving cell to which a user equipment belongs and is used to instruct to allocate the user equipment with a resource for sending the uplink signal. The second allocating unit 702 is configured to allocate, according to the resource allocation command received by the second receiving unit 701, the user equipment with a network resource for sending the uplink signal.

As shown in FIG. 7B, the apparatus for transmitting an uplink signal of this embodiment may further include a second sending unit 703. The second sending unit 703 is configured to send information of the network resource to the serving cell network element.

In the apparatus for transmitting an uplink signal according to this embodiment, a neighboring cell of a serving cell, that is, a scheduling cell, allocates the user equipment with the network resource for sending the uplink signal, which can lighten a burden of the serving cell network element, thereby ensuring fluency of signal transmission of the user equipment as far as possible.

### Embodiment 9

This embodiment provides an apparatus for transmitting an uplink signal, for executing the method for transmitting an uplink signal of Embodiment 5. The apparatus for transmitting an uplink signal may be integrated in a user equipment.

FIG. 8 is a schematic structural diagram of an apparatus for transmitting an uplink signal according to this embodiment. The apparatus for transmitting an uplink signal includes a third receiving unit 801 and a third sending unit 802.

The third receiving unit 801 is configured to receive information, which is forwarded by a serving cell network element of a serving cell to which a user equipment belongs, of a network resource allocated by a scheduling cell for sending the uplink signal, where the scheduling cell is a neighboring cell of the serving cell with a power loss less than a first power loss of the serving cell network element, the first power loss is a power loss generated during signal transmission between the serving cell network element and the user equipment, and a second power loss is a power loss generated during signal transmission between a neighboring cell network element of at least one neighboring cell of the serving cell and the user equipment. The third sending unit 802 is configured to send an uplink signal according to the information of the network resource received by the third receiving unit 801.

Optionally, the third receiving unit 801 is further configured to receive information of N receiving cells delivered by the serving cell network element, where N is an integer greater than or equal to 1.

The third sending unit is specifically configured to:

send the uplink signal to receiving cell network elements of the N receiving cells according to the information of the network resource of the uplink signal, so that the N receiving cell network elements perform a COMP operation to generate an enhanced uplink signal, and send the enhanced uplink signal to the serving cell network element.

In the apparatus for transmitting an uplink signal of this embodiment, the uplink signal is sent by using the network resource allocated by the scheduling cell network element, which can lighten a burden of the serving cell network element, thereby ensuring fluency of signal transmission of the user equipment as far as possible.

### Embodiment 10

This embodiment provides another apparatus for transmitting an uplink signal. The apparatus for transmitting an uplink signal may be integrated in a serving cell network element of a serving cell, and the serving cell network element may specifically be a base station.

The apparatus for transmitting an uplink signal of this embodiment includes at least one first processor and a first memory, the first memory being configured to store an executable program code, where the first processor runs a program corresponding to the executable program code by reading an executable program code stored in the first memory, so as to be configured to:

receive information that is of a network resource and sent by a scheduling cell, where the scheduling cell is a neighboring cell of a serving cell to which a user equipment belongs; and

send the information of the network resource to the user equipment, so that the user equipment sends the uplink signal by using the network resource.

Optionally, before the first processor runs the program corresponding to the executable program code by reading the executable program code stored in the first memory, so as to be configured to receive information that is of the network resource and sent by the scheduling cell, the first processor may further run the program corresponding to the executable program code by reading the executable program code stored in the first memory, so as to be configured to:

obtain a first power loss generated during signal transmission between the serving cell network element of the serving cell to which the user equipment belongs and the user equipment;

obtain a second power loss generated during signal transmission between a neighboring cell network element of at least one neighboring cell of the serving cell and the user equipment;

determine whether the second power loss is less than the first power loss, and when a determination result is yes, use a cell corresponding to the second power loss as the scheduling cell; and

instruct a scheduling cell network element of the scheduling cell to allocate the user equipment with a network resource for sending the uplink signal.

Optionally, before the first processor runs the program corresponding to the executable program code by reading the executable program code stored in the first memory, so as to be configured to instruct the scheduling cell network element of the scheduling cell to allocate the user equipment with the network resource for sending the uplink signal, the first processor may run the program corresponding to the executable program code by reading the executable program code stored in the first memory, so as to be configured to:

determine whether the first power loss is greater than a first preset threshold, and determine whether the second power loss is less than a second preset threshold, and when determination results are yes, execute the operation of instructing a scheduling cell network element of the scheduling cell to allocate the user equipment with a network resource for sending the uplink signal.

Optionally, when the first processor runs the program corresponding to the executable program code by reading the executable program code stored in the first memory, so as to be configured to determine whether the first power loss is greater than a first preset threshold, and determine whether the second power loss is less than a second preset threshold, if multiple second power losses are less than the second preset threshold, a neighboring cell corresponding to the second power loss with a minimum value is used as the scheduling cell.

Optionally, before the first processor runs the program corresponding to the executable program code by reading the executable program code stored in the first memory, so as to be configured to instruct the scheduling cell network element of the scheduling cell to allocate the user equipment with the network resource for sending the uplink signal, the first processor may run the program corresponding to the executable program code by reading the executable program code stored in the first memory, so as to be configured to:

determine whether a difference between the first power loss and the second power loss is greater than a preset threshold value, and when a determination result is yes, execute the operation of instructing a scheduling cell network element of the scheduling cell to allocate the user equipment with a network resource for sending the uplink signal.

Optionally, when the first processor runs the program corresponding to the executable program code by reading the executable program code stored in the first memory, so as to be configured to determine whether a difference between the first power loss and the second power loss is greater than a preset threshold value, and when there are differences between multiple second power losses and the first power loss less than the preset threshold value, a cell corresponding to the second power loss with a minimum value is used as the scheduling cell.

Optionally, the first processor runs a program corresponding to the executable program code by reading the executable program code stored in the first memory, so as to be configured to obtain the first power loss generated during signal transmission between the serving cell network element to which the user equipment belongs and the user equipment, where the operation may specifically be:

receiving a DL RSRP, which is sent by the user equipment and obtained through measurement, of the serving cell network element; and

obtaining, according to the DL RSRP of the serving cell network element and a preset downlink reference signal transmit power of the serving cell network element, the first power loss generated during signal transmission between the serving cell network element and the user equipment.

Optionally, the first processor runs a program corresponding to the executable program code by reading the executable program code stored in the first memory, so as to be configured to obtain the second power loss generated during signal transmission between a neighboring cell network element of at least one neighboring cell of the serving cell and the user equipment, where the operation may specifically be:

receiving a DL RSRP, which is sent by the user equipment and obtained through measurement, of the neighboring cell network element of the at least one neighboring cell; and

obtaining, according to the DL RSRP of the neighboring cell network element and a preset downlink reference signal transmit power of the neighboring cell network element, the second power loss generated during signal transmission between the neighboring cell network element and the user equipment.

Optionally, the first processor runs a program corresponding to the executable program code by reading the executable program code stored in the first memory, so as to be configured to obtain the second power loss generated during signal transmission between at least one neighboring cell network element of the serving cell and the user equipment, where the operation may specifically be:

receiving an SRS received power or a DMRS received power of the user equipment, which is sent by the at least one neighboring cell network element of the serving cell and obtained through measurement by the neighboring cell network element; and

obtaining a power loss generated during signal transmission between the neighboring cell network element and the user equipment according to the SRS received power and a preset SRS transmit power, or obtaining, according to the DMRS received power and a preset DMRS transmit power, a power loss generated during signal transmission between the neighboring cell network element and the user equipment.

Optionally, the first processor may further run the program corresponding to the executable program code by reading the executable program code stored in the first memory, so as to be configured to:

arrange the first power loss and the at least one second power loss in an order from small to large, and select cells corresponding to first N power losses as receiving cells, or randomly select cells corresponding to N power losses with values less than a third threshold as receiving cells, where N is an integer greater than or equal to 1;

receive an enhanced uplink signal sent by the user equipment using the network resource via receiving cell network elements of the receiving cells, where the enhanced uplink signal is generated through a COMP operation or a joint transmission operation by the N receiving cell network elements for the uplink signal; and

decode the enhanced uplink signal, to obtain uplink data.

Optionally, when the serving cell is the scheduling cell, the first processor may further run the program corresponding to the executable program code by reading the executable program code stored in the first memory, so as to be configured to: and the method for transmitting an uplink signal specifically may be:

allocating a time-frequency resource to the user equipment.

In the apparatus for transmitting an uplink signal according to this embodiment, the uplink signal is sent by using the network resource of the neighboring cell of the serving cell, which can lighten a network burden of the serving cell, thereby ensuring fluency of signal transmission of the user equipment as far as possible.

### Embodiment 11

This embodiment provides another apparatus for transmitting an uplink signal. The apparatus for transmitting an uplink signal may specifically be integrated in a scheduling cell network element of a scheduling cell. The specific method for determining the scheduling cell may be consistent with that in the foregoing embodiments, and details will not be described herein again.

The apparatus for transmitting an uplink signal of this embodiment includes at least one second processor and a second memory, the second memory being configured to store an executable program code, where the second processor runs a program corresponding to the executable program code by reading an executable program code stored in the second memory, so as to be configured to:

receive a resource allocation command, which is sent by a serving cell network element of a serving cell to which a user equipment belongs and is used to instruct to allocate the user equipment with a resource for sending the uplink signal; and

allocate, according to the resource allocation command, the user equipment with a network resource for sending the uplink signal.

Optionally, the second processor may further run the program corresponding to the executable program code by reading the executable program code stored in the second memory, so as to be configured to:

send information of the network resource to the serving cell network element.

In this embodiment, the apparatus for transmitting an uplink signal in the scheduling cell allocates the user equipment with the network resource for sending the uplink signal, which can lighten a burden of the serving cell network element, thereby ensuring fluency of signal transmission of the user equipment as far as possible.

### Embodiment 12

This embodiment provides another apparatus for transmitting an uplink signal. The apparatus for transmitting an uplink signal may specifically be integrated in a user equipment.

The apparatus for transmitting an uplink signal of this embodiment includes at least one third processor and a third memory, the third memory being configured to store an executable program code, where the third processor runs a program corresponding to the executable program code by reading an executable program code stored in the third memory, so as to be configured to:

receive information, which is forwarded by a serving cell network element of a serving cell to which a user equipment belongs, of a network resource allocated by a scheduling cell for sending the uplink signal; and

send the uplink signal according to the information of the network resource.

The scheduling cell is a neighboring cell of the serving cell with a power loss less than a first power loss of the serving cell network element, the first power loss is a power loss generated during signal transmission between the serving cell network element and the user equipment, and a second power loss is a power loss generated during signal transmission between a neighboring cell network element of at least one neighboring cell of the serving cell and the user equipment.

Optionally, the third processor may further run the program corresponding to the executable program code by reading the executable program code stored in the third memory, so as to be configured to:

receive information of N receiving cells delivered by the serving cell network element, where N is an integer greater than or equal to 1; and

the sending the uplink signal to the serving cell network element of the serving cell to which the user equipment belongs includes:

sending the uplink signal to receiving cell network elements of the N receiving cells, so that the N receiving cell network elements perform a COMP operation to generate an enhanced uplink signal, and sending the enhanced uplink signal to the serving cell network element.

In the apparatus for transmitting an uplink signal of this embodiment, the uplink signal is sent by using the network resource allocated by the scheduling cell network element, which can lighten a network burden of the serving cell network element, thereby ensuring fluency of signal transmission of the user equipment as far as possible.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, as long as such modifications or replacements do not cause the essence of corresponding technical solutions to depart from the scope of the technical solutions of the embodiments of the present invention.

What is claimed is:

1. A method for transmitting an uplink signal, comprising:
receiving, by a serving cell network element of a serving cell to which a user equipment belongs, information regarding a network resource and that is sent by a scheduling cell, wherein the scheduling cell is a neighboring cell of the serving cell; and
sending, by the serving cell network element, the information regarding the network resource to the user equipment, so that the user equipment sends the uplink signal by using the network resource.

2. The method according to claim 1, wherein the method further comprises performing, before the receiving the information regarding the network resource:
obtaining a first power loss generated during signal transmission between the serving cell network element and the user equipment;
obtaining a second power loss generated during signal transmission between a neighboring cell network element of at least one neighboring cell of the serving cell and the user equipment;
determining whether the second power loss is less than the first power loss, and, in response to the second power loss being less than the first power loss, using a cell corresponding to the second power loss as the scheduling cell; and
instructing a scheduling cell network element of the scheduling cell to allocate the user equipment with the network resource for sending the uplink signal.

3. The method according to claim 2, wherein the method further comprises performing, before the instructing the scheduling cell network element to allocate the user equipment with the network resource:
determining whether the first power loss is greater than a first preset threshold, and determining whether the second power loss is less than a second preset threshold, and, in response to the first power loss being greater than the first preset threshold, and further in response to the second power loss being less than the second preset threshold, executing the instructing the scheduling cell network element to allocate the user equipment with the network resource.

4. The method according to claim 3, further comprising:
using a neighboring cell corresponding to a second power loss with a minimum value as the scheduling cell in response to multiple second power losses being less than the second preset threshold.

5. The method according to claim 2, the method further comprising performing, before the instructing the scheduling cell network element to allocate the user equipment with the network resource:
determining whether a difference between the first power loss and the second power loss is greater than a preset threshold value, and, in response to the difference being greater than the preset threshold value, performing the instructing the scheduling cell network element to allocate the user equipment with the network resource.

6. The method according to claim 5, further comprising:
using a cell corresponding to a second power loss with a minimum value as the scheduling cell in response to differences between multiple second power losses and the first power loss being less than the preset threshold value.

7. A method for transmitting an uplink signal, comprising:
receiving, by a scheduling cell network element of a scheduling cell, a resource allocation command sent by a serving cell network element of a serving cell to which a user equipment belongs, wherein the resource allocation command is used to instruct the scheduling cell network element to allocate the user equipment with a resource for sending the uplink signal, wherein the scheduling cell is a neighboring cell of the serving cell; and
allocating, by the scheduling cell network element according to the resource allocation command, the user equipment with a network resource for sending the uplink signal.

8. The method according to claim 7, further comprising:
sending information regarding the network resource to the serving cell network element.

9. A method for transmitting an uplink signal, comprising:
receiving, by a user equipment, information, which is forwarded by a serving cell network element of a serving cell to which the user equipment belongs, regarding a network resource allocated by a scheduling cell for sending the uplink signal, wherein the scheduling cell is a neighboring cell of the serving cell; and
sending the uplink signal according to the information regarding the network resource.

10. The method according to claim 9, wherein the neighboring cell has a second power loss less than a first power loss of the serving cell network element, wherein the first power loss is a power loss generated during signal transmission between the serving cell network element and the user equipment, and wherein the second power loss is a power loss generated during signal transmission between a neighboring cell network element of the neighboring cell and the user equipment.

11. The method according to claim 9, further comprising:
receiving information of N receiving cells delivered by the serving cell network element, wherein N is an integer greater than or equal to 1;
wherein the sending the uplink signal to the serving cell network element comprises:
sending the uplink signal to receiving cell network elements of the N receiving cells, so that the N receiving cell network elements performs a coordinated multi-point transmission/reception (COMP) operation to generate an enhanced uplink signal; and
sending the enhanced uplink signal to the serving cell network element.

12. An apparatus for transmitting an uplink signal, comprising:
at least one processor; and
a non-transitory computer readable memory connected to the at least one processor, the memory having executable program code stored thereon that, when executed by the processor, causes the processor to:
receive information regarding a network resource and that is sent by a scheduling cell, wherein the scheduling cell is a neighboring cell of a serving cell to which a user equipment belongs, and wherein the apparatus for transmitting the uplink signal is located in a serving cell network element of the serving cell; and
send the information regarding the network resource to the user equipment, so that the user equipment sends the uplink signal by using the network resource.

13. The apparatus according to claim 12, wherein the memory further has executable program code stored thereon that, when executed by the processor, causes the processor to, before receiving the information regarding the network resource:
obtain a first power loss generated during signal transmission between the serving cell network element and the user equipment;
obtain a second power loss generated during signal transmission between a neighboring cell network element of at least one neighboring cell of the serving cell and the user equipment;
determine whether the second power loss is less than the first power loss, and use a cell corresponding to the second power loss as the scheduling cell in response to the second power loss being less than the first power loss; and
instruct a scheduling cell network element of the scheduling cell to allocate the user equipment with the network resource for sending the uplink signal.

14. The apparatus according to claim 13, wherein the memory further has executable program code stored thereon that, when executed by the processor, causes the processor to, before instructing the scheduling cell network element to allocate the user equipment with the network resource:
determine whether the first power loss is greater than a first preset threshold, and determining whether the second power loss is less than a second preset threshold, and, in response to the first power loss being greater than the first preset threshold, and further in response to the second power loss being less than the second preset threshold, execute the program code causing the processor to instruct the scheduling cell network element to allocate the user equipment with the network resource.

15. The apparatus according to claim 14, wherein a neighboring cell corresponding to a second power loss with a minimum value is used as the scheduling cell in response to multiple second power losses being less than the second preset threshold.

16. The apparatus according to claim 13, wherein the memory further has executable program code stored thereon that, when executed by the processor, causes the processor to, before instructing the scheduling cell network element to allocate the user equipment with the network resource:
determine whether a difference between the first power loss and the second power loss is greater than a preset threshold value, and execute, in response to the first power loss and the second power loss being greater than a preset threshold value. the program code causing the processor to instruct the scheduling cell network element to allocate the user equipment with the network resource.

17. The apparatus according to claim 16, wherein a cell corresponding to a second power loss with a minimum value is used as the scheduling cell in response to differences between multiple second power losses and the first power loss being less than the preset threshold value.

18. An apparatus for transmitting an uplink signal, comprising:
at least one processor; and
a non-transitory computer readable memory connected to the at least one processor, the memory having executable program code stored thereon that, when executed by the processor, causes the processor to:
receive a resource allocation command, which is sent by a serving cell network element of a serving cell and is used to instruct to allocate a user equipment with a resource for sending the uplink signal, wherein a scheduling cell is a neighboring cell of the serving cell to which the user equipment belongs, and wherein the apparatus for transmitting the uplink signal is located in a scheduling cell network element of the scheduling cell; and
allocate, according to the resource allocation command, the user equipment with a network resource for sending the uplink signal.

19. An apparatus for transmitting an uplink signal, located in a user equipment, comprising:
at least one processor; and
a non-transitory computer readable memory connected to the at least one processor, the memory having executable program code stored thereon that, when executed by the processor, causes the processor to:
receive information, which is forwarded by a serving cell network element of a serving cell to which the user equipment belongs, regarding a network resource allocated by a scheduling cell for sending the uplink signal, wherein the scheduling cell is a neighboring cell of the serving cell; and
send the uplink signal according to the information regarding the network resource.

20. The apparatus according to claim 19, wherein the scheduling cell has a second power loss less than a first power loss of the serving cell network element, wherein the first power loss is a power loss generated during signal transmission between the serving cell network element and the user equipment, and wherein the second power loss is a power loss generated during signal transmission between a neighboring cell network element of at least one neighboring cell of the serving cell and the user equipment.

21. The apparatus according to claim 19, wherein the memory further has executable program code stored thereon that, when executed by the processor, causes the processor to:
receive information of N receiving cells delivered by the serving cell network element, wherein N is an integer greater than or equal to 1;
wherein the program code causing the processor to send the uplink signal to the serving cell network element comprises executable program code that, when executed by the processor, causes the processor to:
send the uplink signal to receiving cell network elements of the N receiving cells, so that the N receiving cell network elements performs a coordinated multi-point transmission/reception (COMP) operation to generate an enhanced uplink signal, and
send the enhanced uplink signal to the serving cell network element.
